(19) United States
(12) Patent Application Publication
(10) Pub. No.: US 2025/0030310 A1
(43) Pub. Date: Jan. 23, 2025

(54) ELECTRIC MOTOR

(71) Applicant: BorgWarner Inc., Auburn Hills, MI (US)

(72) Inventors: Silvio Koch, Kirchheimbolanden (DE); Thomas Ramb, Worms (DE)

(21) Appl. No.: 18/769,358

(22) Filed: Jul. 10, 2024

(30) Foreign Application Priority Data
Jul. 21, 2023 (DE) 20 2023 104 096.9

(51) Int. Cl. H02K 7/08; F16C 19/28; F16C 33/58

(52) U.S. Cl. CPC H02K 7/086; F16C 19/28; F16C 33/581; F16C 2380/26

(57) ABSTRACT

An electric motor has a stator and a rotor. A shaft is attached to the rotor and is supporting by a rolling bearing. The rolling bearing is a double-row angular rolling bearing.

### RELATED APPLICATIONS

This application claims priority to DE 20 2023 104 096.9, filed Jul. 21, 2023, the entire disclosure of which is hereby incorporated herein by reference.

### BACKGROUND

This disclosure is based on an electric motor of the type generally known, for example, from U.S. Pat. No. 11,374,465 B2.

A constant goal in the development of electric motors is to mount the shaft with as little play as possible in the most compact structure at the lowest possible cost. This is usually made difficult by the fact that components made of different materials with different thermal expansion coefficients are used in an electric motor, for example, aluminum and steel, which leads to mechanical stresses and relative movements when operating temperatures vary significantly.

The problems associated with thermal expansion can be reduced by using rolling bearings arranged outside the stator to support the shaft, as is the case with the electric motor known from U.S. Pat. No. 11,374,465 B2. This largely avoids excessive heating of the bearings due to waste heat from the rotor or stator. However, this makes a compact design of the electric motor more difficult.

### SUMMARY

This disclosure shows how the shaft in a compact electric motor can be mounted with little play at low cost.

An electric motor according to this disclosure contains a double-row angular rolling bearing to support the shaft. In this way, play can be largely avoided and a compact design can be realized.

An advantageous refinement of this disclosure provides for the angular rolling bearing to have two rows of rolling elements, with the two rows of rolling elements bearing against different components on a radial side and bearing against the same component on an opposite side. For example, the angular rolling bearing may have a multi-part outer ring or an inner ring on which only one of the two rows of rolling elements is in contact, while the other row of rolling elements is in contact with another component, for example, the shaft. By having the two rows of rolling elements in contact with a total of three different components, play in the bearing can be advantageously minimized.

An advantageous refinement of this disclosure provides that at least one of the two rows of rolling elements of the angular rolling bearing bears against the shaft. In this way, the angular rolling bearing and the shaft can be combined to form a compact assembly with few components. Preferably, the shaft has a recess into which an inner ring is fitted, which bears against one of the two rows of rolling elements of the angular rolling bearing, while the other row of rolling elements bears directly against the shaft. In this way, play in the bearing can be reduced as far as possible, in particular by fitting the inner ring with a preload into the recess in the shaft.

As an alternative to fitting the inner ring into a recess in the shaft, the inner ring can also be fixed by a material or friction connection. In this case, the inner ring can be connected directly to the shaft or connected to the shaft by means of another ring.\

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a sectional view of an embodiment of an electric motor according to this disclosure.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

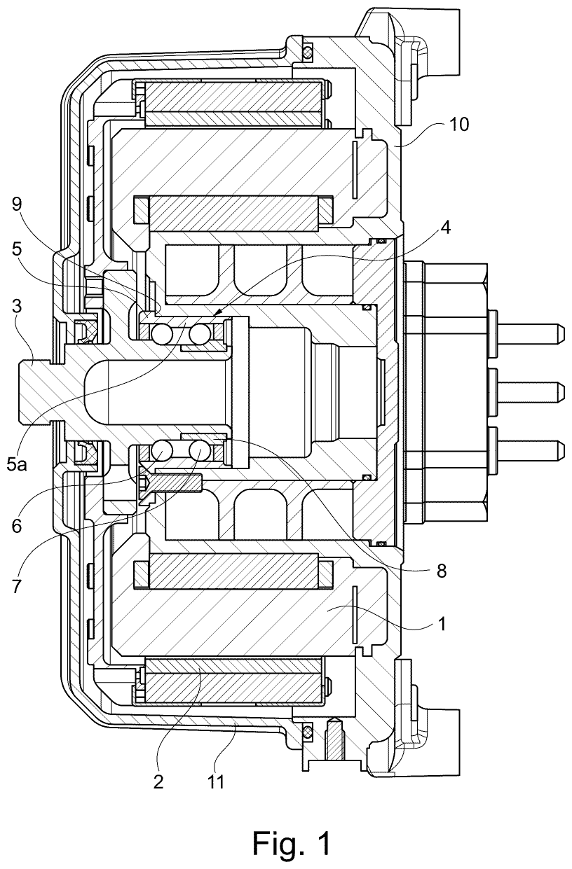

The electric motor shown in FIG. 1 comprises a stator 1 with stator windings and a rotor 2 with permanent magnets surrounding the stator 1. The electric motor shown is therefore an external rotor motor.

The rotor 2 is attached to a shaft 3, which is supported by a double-row angular contact rolling bearing 4. The rolling elements of the angular rolling bearing 4 may be, for example, balls or other rolling bodies, such as cones. The angular rolling bearing 4 comprises an outer ring 5 and two rows of rolling elements 6, 7, over which the outer ring 5 extends. The outer ring 5 has a protrusion 5a that protrudes radially inwards between the two rows of rolling elements 6, 7. The two rows of rolling elements 6, 7 abut on the protrusion 5a of the outer ring 5 on opposite sides.

As FIG. 1 shows, the angular rolling bearing 4 comprises an inner ring 8 abutting one of the two rows of rolling elements 6, 7, namely, the row of rolling elements 7. The other row of rolling elements 6 abuts directly on the shaft 3. The inner ring 8 is fitted into a recess in the shaft 3. The inner ring 8 forms a stop against which one of the two rows of rolling elements, namely rolling element row 7, abuts and is thus axially fixed. The other row of rolling elements 6 rests against a protrusion formed by the shaft 3. The angular rolling bearing 4 thus supports the shaft 3 over a relatively long length, which makes it more difficult for the shaft 3 to tilt.

The outer ring 5 may have an annular shoulder 9, which forms a stop for the axial positioning of the angular rolling bearing 4. The annular shoulder 9 may, for example, abut the stator 1, a housing part 10 surrounding the stator 1 or another component of the electric motor that is fixed relative to the stator 1.

The angular rolling bearing 4, or more precisely the outer ring 5 of the angular rolling bearing 4, may be fixed in the stator housing relative to the stator 1 using a snap ring or screws, for example.

This design of the angular rolling bearing 4 allows simple adjustment of the axial play with very little play and an advantageously compact design. In particular, the angular rolling bearing 4 may be preloaded and the axial play thus reduced to zero. The angular rolling bearing 4 can be arranged completely in the stator 1 and thus enables an advantageously compact design.

The shaft 3 may be designed as a hollow shaft to save weight. In the embodiment shown, stator 1 and rotor 2 are arranged in a two-part housing, which has a pot-like housing part 11 and a housing part 10 that closes this housing part 11. The shaft 3 protrudes from the pot-like housing part 11. Stator 1 and rotor 2 can thus be arranged in an interior sealed against water and environmental influences.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 Stator
2 Rotor
3 Shaft
4 Angular rolling bearing
5 Outer ring
5a Lead
6 Rolling element series
7 Rolling element series
8 Inner ring
9 Shoulder
10 Housing part
11 Housing part

What is claimed is:

1. An electric motor, comprising:
a stator;
a rotor; and
a shaft attached to the rotor and being supported by a rolling bearing, wherein the rolling bearing is a double-row angular rolling bearing.

2. The electric motor according to claim 1, wherein the angular rolling bearing comprises two rows of rolling elements, the two rows of rolling elements abutting different components on one radial side and bearing against the same component on an opposite side.

3. The electric motor according to claim 1, wherein the angular rolling bearing comprises an outer ring which extends over both rows of rolling elements, and an inner ring which extends over only one of the two rows of rolling elements.

4. The electric motor according to claim 3, wherein one of the two rows of rolling bearings abuts the shaft and the other row of rolling bearings abuts the inner ring.

5. The electric motor according to claim 3, wherein the outer ring has a protrusion which protrudes between the two rows of rolling bearings and which abuts the two rows of rolling bearings on opposite sides.

6. The electric motor according to claim 5, wherein the shaft has a stop which, together with the protrusion of the outer ring, axially fixes one of the two rows of rolling bearings.

7. The electric motor according to claim 5, wherein the inner ring has a stop which, together with the protrusion of the outer ring, axially fixes one of the two rows of rolling bearings.

8. The electric motor according to claim 3, wherein the inner ring is fitted into a recess in the shaft.

9. The electric motor according to claim 3, wherein the outer ring has a shoulder which forms a stop for axial positioning of the angular rolling bearing.

10. The electric motor according to claim 1, wherein the angular rolling bearing is a ball bearing.

11. The electric motor according to claim 1, wherein the angular rolling bearing is fixed with a snap ring.

12. The electric motor according to claim 1, wherein the angular rolling bearing is fixed by means of screws.

13. The electric motor according to claim 1, wherein the shaft is a hollow shaft.

14. The electric motor according to claim 1, wherein the rotor is an external rotor which surrounds the stator.

15. The electric motor according to claim 1, wherein the angular rolling bearing is surrounded over its entire length by the stator.
